(19) United States
(12) Patent Application Publication
(10) Pub. No.: US 2003/0058891 A1
(43) Pub. Date: Mar. 27, 2003

(54) Low noise transmitter architecture using foldover selective band filtering and method thereof

(76) Inventors: Dan Nobbe, Crystal Lake, IL (US); Donald Yochem, Buffalo Grove, IL (US)

Correspondence Address: MOTOROLA INC, 600 NORTH US HIGHWAY 45, LIBERTYVILLE, IL, 60048-5343, US

(21) Appl. No.: 09/960,691

(22) Filed: Sep. 21, 2001

(51) Int. Cl. H04J 1/02

(52) U.S. Cl. 370/488; 370/343

(57) ABSTRACT

The present invention describes an apparatus capable of producing a radio frequency (RF) transmit (Tx) signal for a radiotelephone low enough in noise without requiring a post power amplifier (PA) cleanup filter.

A Tx signal generated by a modulator (710) is sent through a different filter by a first and second switches (714 and 728) based upon the frequency of the Tx signal, and each of the filters (720 and 724) are designed to reduce the noise floor of a certain predetermined region within a specific TX band. The noise floor of the Tx signal contributes to production of foldover noise due to intermodulation phenomenon caused by nonlinearity of the PA (732). However, because the portion of the noise floor within the Tx band is reduced by going through the appropriate bandpass filter for the Tx signal and because the foldover noise production is a nonlinear phenomenon, the resulting reduced noise floor contributes significantly less to the foldover noise generated by the PA (732)

### FIELD OF THE INVENTION

The present invention relates generally to the field of radio communications. More specifically, the present invention relates to a transmitter architecture utilizing foldover selective band filtering to produce low noise transmission signal.

### BACKGROUND OF THE INVENTION

As a new generation of radiotelephones is introduced, it is expected that the new phone is more capable and more efficient. Such new phone may be able to support multiple systems and standards, which were traditionally incompatible, such as time-division-multiple-access (TDMA) and global-system for mobile (GSM), and be able to provide longer talk time without increasing in size. For example, a radiophone expected to be operated in TDMA and GSM systems may be required to operate in four distinct radio frequency (RF) bands: 800 MHz, 900 MHz, 1800 MHz, and 1900 MHz.

Today's common transmitter (Tx) architecture employed in a radiophone uses a post power amplifier (PA) filter in order for the phone to meet the specified receiver (Rx) band noise requirement imposed by the specific standard for the particular RF band and system the phone operates in. One of the sources for the noises contributing to the Rx band is generated by a mechanism commonly referred to as PA noise foldover. The PA noise foldover is described as an intermodulation (IM) phenomenon where the Tx inband noise is intermodulated (or mixed) in the PA device with the much higher power carrier signal, and resulting noise appears in the system Rx band. The level of the Rx band noise converted from the Tx noise depends on the conversion loss the PA device.

FIG. 1 illustrates a traditional Tx lineup for a radiophone. FIG. 2 illustrates the Tx and Rx bands used in the Personal Communications Systems (PCS). The Tx band has a bandwidth, Tx_{BW} 210, of 60 MHz with the lowest Tx frequency, Txₘᵢₙ 212, of 1850 MHz and the highest Tx frequency, Txₘₐₓ 214, of 1910 MHz. The Rx band has a bandwidth, Rx_{BW} 216, of 60 MHz with the lowest Rx frequency, Rxₘᵢₙ 218, of 1930 MHz and the highest Rx frequency, Rxₘₐₓ 220, of 1990 MHz. The frequency gap between the Tx and Rx bands, Int 222, is 20 MHz. FIG. 3 illustrates the noise floor, N_{fl} 310, present on the line 112 at the output of the generic modulator 110 before the filter 114 of the Tx signal 312 of the radiophone transmitting at the carrier frequency, f_{c} 314, equal to Txₘₐₓ 316 of 1910 MHz. The filter 114 typically has low insertion loss, Tx_{IL} 410, in the Tx band 422 and has much higher insertion loss, Rx_{IL} 412, outside of the Tx band as illustrated in FIG. 4. When the Tx signal 510 at f_{c} and its associated noise go through the filter 114, the noise floor present on the line 116 in the Tx band 512 is reduced from N_{fl} 514 by the insertion loss of Tx_{IL} 516 to N_{Tx} 518, and the noise floor in the Rx band 520 is reduced from N_{fl} 514 by the insertion loss of Rx_{IL} 522 to N_{Rx} 524 as illustrated in FIG. 5.

A representation of the signal observed at the output of the PA 118 is illustrated in FIG. 6. The PA 118 amplifies by the Tx signal 510 and N_{Tx} 518 by a gain factor G_{PA} 610, and produces the Tx signal 612 along with the N_{Tx} 614. In addition, due to nonlinearities in the PA 118, the noise floor N_{Tx} 518 from 1850 MHz to 1910 MHz would be effectively folded over about the Tx signal 612 located at f_{c}=1910 MHz, and would be converted with the conversion loss, L_{fold} 616, to appear as N_{Rx}_{_{—}}ₒᵤₜ 618 from 1910 MHz to 1970 MHz as illustrated in FIG. 6. A portion 620 of N_{Rx}_{_{—}}ₒᵤₜ 618, overlapping the Rx band 622 from 1930 MHz to 1970 MHz, must be reduced to meet the system Rx band noise requirement 624 imposed by the standard.

For a radiophone designed to be operated in four different bands, the Rx noise requirement may necessitate using four different post PA filters such as 122 illustrated in FIG. 1, each of which is designed specifically to meet the Rx noise requirement for one of the bands. These post PA filters are generally large relative to the size of the radiophone, and are costly. By eliminating these filters, the radiophone can be made smaller with less cost. In addition, the insertion loss through the filter, which the PA must overcome, would be eliminated thereby increasing the overall efficiency of the transmitter. For example, if the loss through the post PA filter were 3 dB and if the desired power output were 30 dBm (or 1 Watt), then in order to overcome the loss, the PA would be required to produce 3 dB more power, or 33 dBm (or 2 Watts), at the output of the PA. This means that one half of the power produced would have to be lost in order to reduce the undesired noise. The loss through the post PA filter would vary depending on the requirement imposed by the standard and the type of a filter used, however, a significant portion of the RF power produced by the PA would still be lost. By eliminating the filter after the PA, the output power requirement of the PA would be reduced. With the reduced output power requirement, the PA would consume less power, which would lead to a longer talk time, and a smaller and less expensive PA device might be used. Therefore, by eliminating the post PA filter or filters, and utilizing a smaller PA device or devices, the overall size of the radiophone may be reduced, and its efficiency improved.

### BRIEF DESCRIPTION OF THE DRAWINGS

FIG. 1 is a block diagram of a typical Tx lineup of the prior art;

FIG. 2 is a diagram of PCS Tx and Rx band frequency assignment of the prior art;

FIG. 3 is a diagram of the noise floor present at the output of the modulator 112 of FIG. 1;

FIG. 4 is a diagram of the frequency response of the filter 114 of FIG. 1;

FIG. 5 is a diagram of the noise floor present at the output of the filter 114 of FIG. 1;

FIG. 6 is a diagram of the noise floor present at the output of the PA 118 of FIG. 1 due to Tx noise floor folded over to the Rx band;

FIG. 7 is a block diagram of a preferred embodiment of a transmitter architecture employing split band filters of the present invention;

FIG. 8 is a block diagram of a preferred embodiment of a transmitter architecture employing split band filters of the present invention for the Personal Communications Systems;

FIG. 9 is a frequency response diagram of the first filter 820 of FIG. 8;

FIG. 10 is a frequency response diagram of the second filter 824 of FIG. 8;

FIG. 11 is a representation of the Tx signal on Channel 1998 observed at the output of the modulator 810 of FIG. 8;

FIG. 12 is a representation of the Tx signal on Channel 1998 observed at the input of the PA 832 of FIG. 8; and

FIG. 13 is a representation of the Tx signal on Channel 1998 observed at the output of the PA 832 of FIG. 8.

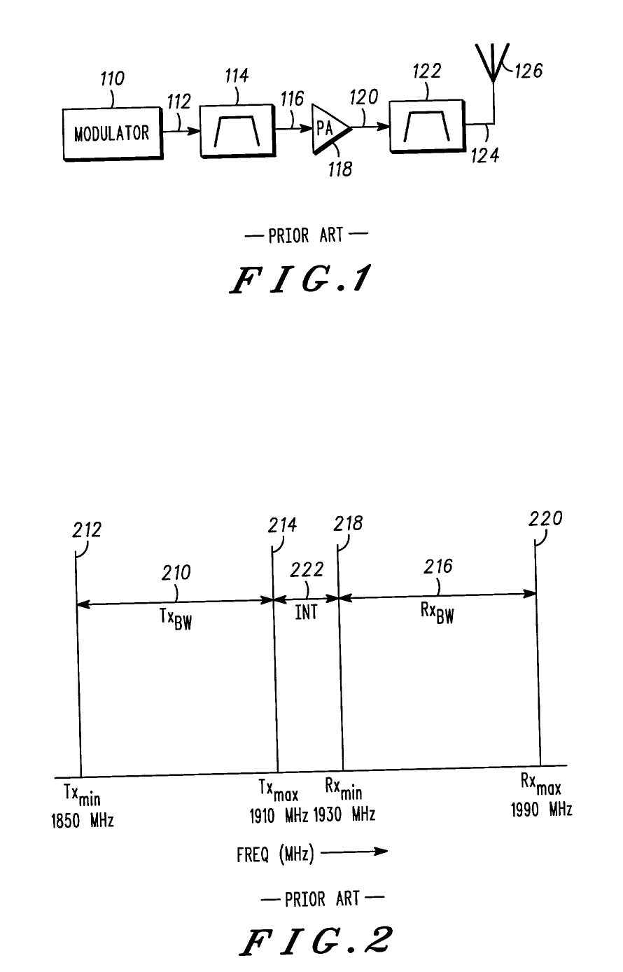

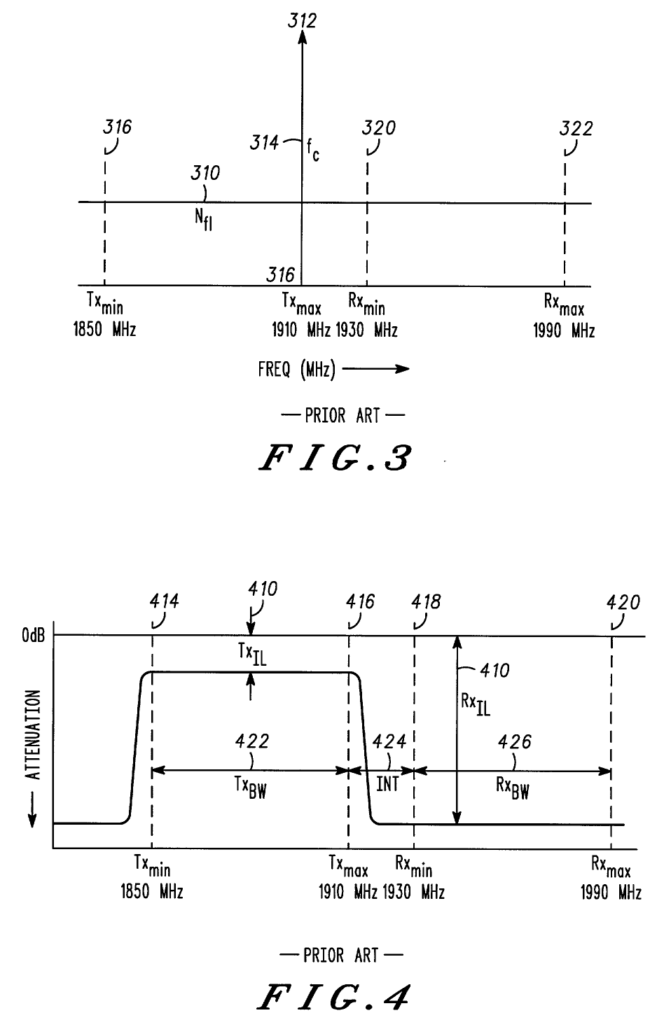

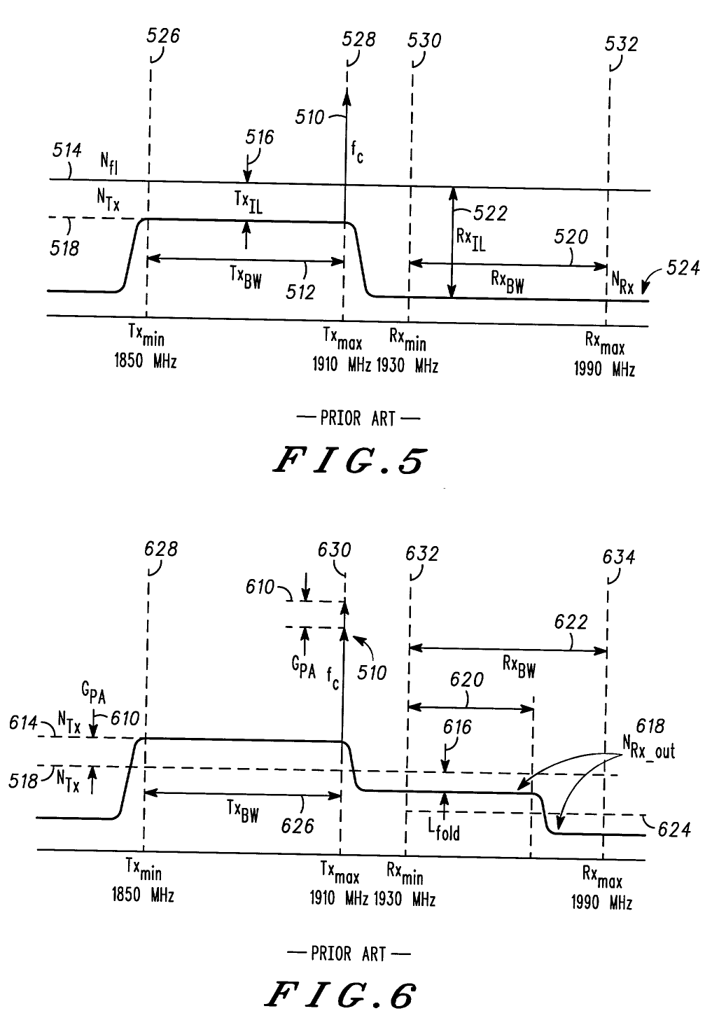

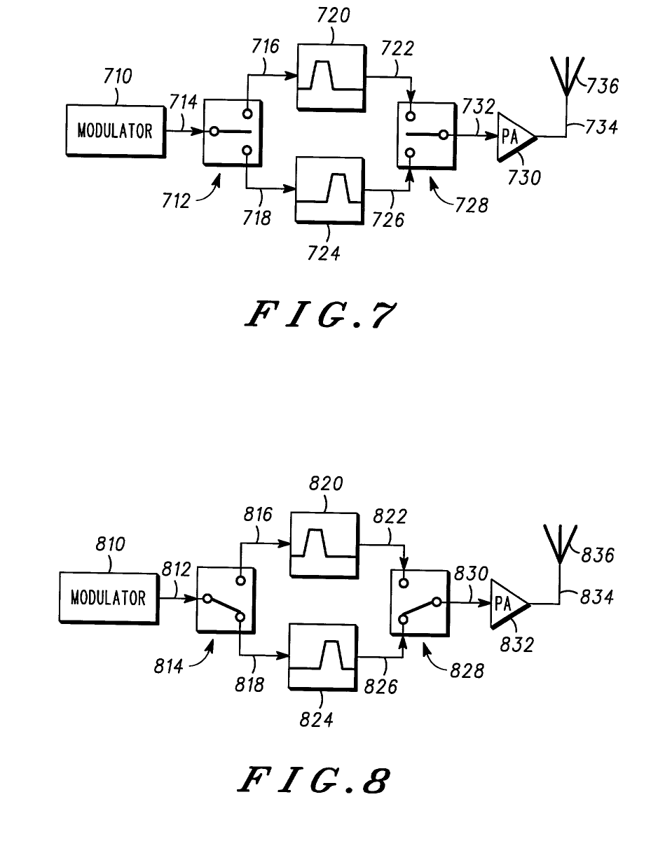

### SUMMARY OF THE INVENTION

The present invention describes an apparatus capable of producing a radio frequency (RF) transmit (Tx) signal for a radiotelephone low enough in noise without requiring a post power amplifier (PA) cleanup filter.

A Tx signal generated by a modulator is sent through a different filter depending on the frequency of the Tx signal within a specific TX band, and each of the filters are designed to reduce the noise floor of a certain predetermined region within a specific TX band. For example, the Personal Communications Systems (PCS) has the Tx band from 1850 MHz to 1910 MHz, and the Tx band may be divided into two bands, one from 1850 MHz to 1890 MHz and another from 1890 MHz to 1910 MHz, utilizing two different filters having corresponding frequency passbands. If the Tx signal generated had a frequency of 1900 MHz, the Tx signal would be routed to go through the filter with the passband from 1890 MHz to 1910 MHz. By going through the filter having the passband from 1890 MHz to 1910 MHz, the 1900 MHz Tx signal would have the noise floor reduced outside of the passband from 1890 MHz to 1910 MHz including a portion of the Tx bands from 1850 MHz to 1890 MHz. The noise floor of the Tx signal contributes to production of foldover noise due to intermodulation phenomenon caused by nonlinearity of the PA. However, because the portion of the noise floor within the Tx band is reduced by going through the appropriate bandpass filter for the Tx signal and because the foldover noise production is a nonlinear phenomenon, the resulting reduced noise floor contributes significantly less to the foldover noise produced by the PA.

### DETAILED DESCRIPTION OF THE PREFERRED EMBODIMENTS

A preferred embodiment of the present invention is illustrated in block diagram form in FIG. 7.

A modulator 710 produces a transmit (Tx) signal on a Tx channel having a frequency substantially equal to that of a desired radio frequency (RF) Tx signal to be transmitted.

A first switch 712, coupled to the modulator to receive the Tx signal by way of line 714, directs the Tx signal to an appropriate predetermined path, line 716 or 718 based upon the Tx channel, producing a first switched Tx signal.

A first filter 720, coupled to the first switch 712 to receive the first switched Tx signal by way of the line 716, produces a first filtered Tx signal on line 722. The first filter 720 has a first passband within the Tx band, provides higher insertion loss outside of the first passband than inside of the first passband.

A second filter 724, coupled to the first switch 712 to receive the first switched Tx signal by way of the line 718, produces a second filtered Tx signal on line 726. The second filter 724 has a second passband that is different from the first passband but still within the Tx band, and provides higher insertion loss outside of the second passband than inside of the second passband.

A second switch 728, coupled to the first and second filters by way of lines 722 and 726, respectively, receives the first or the second filtered Tx signal based upon the Tx channel, producing a second switched Tx signal.

A power amplifier (PA) 730, coupled to the second switch, receives the second switched Tx signal by way of line 732, producing an amplified Tx signal for transmission at a PA output on line 734.

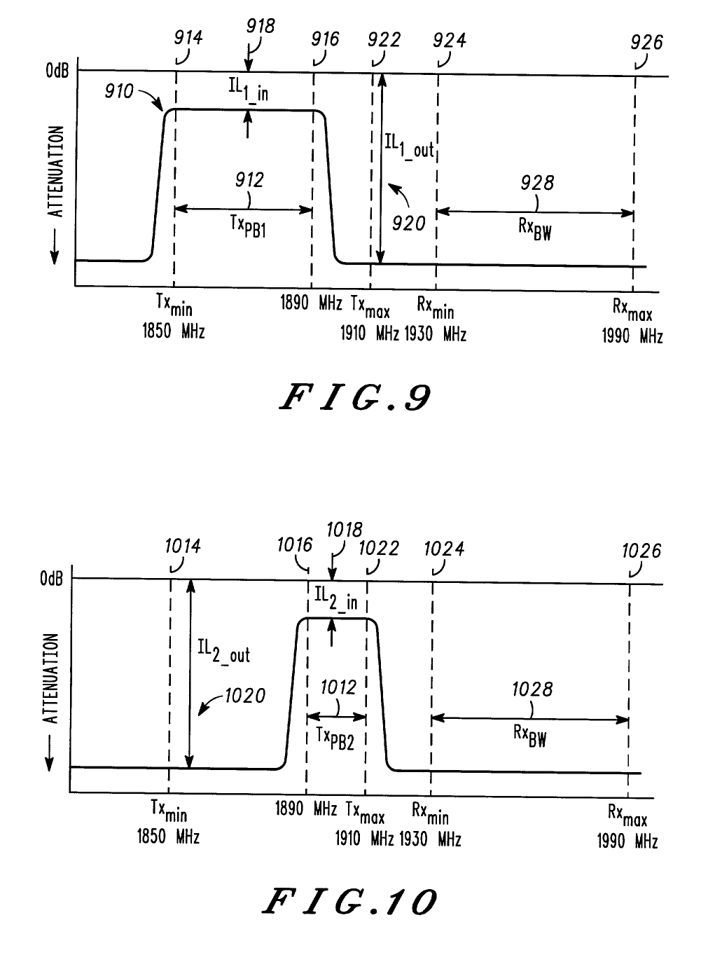

The following example illustrates the operation of the preferred embodiment of the present invention in a radiophone operated in the PCS band. A block diagram of this transmitter architecture example for the Personal Communications Systems band is illustrated in FIG. 8.

The Tx band in the PCS is from about 1850 MHz to about 1910 MHz, and the frequency, Tx_{freq}, corresponding to a channel number, n, may be calculated from the following equation:

Tx_{freq}=0.030*n+1849.98 (MHz) for 1≦n≦1999.

The Rx band in the PCS is from about 1930 MHz to about 1990 MHz, and the frequency, Rx_{freq}, corresponding to a channel number, n, may be calculated from the following equation:

Rx_{freq}=0.030*n+1930.02 (MHz) for 1≦n≦1999.

The phenomenon of the noise foldover is caused by the PA having nonlinear response causing intermodulation between the Tx signal and noise near the Tx signal. For the Tx signal at the highest Tx frequency, the region in the Tx band that can be folded over to appear in and overlap the Rx band is from 1850 MHz to 1890 MHz. As the Tx frequency is decreased, the Tx frequency region of overlapping decreases. For the Tx signal at 1900 MHz, the frequency region in the Tx band of overlapping is from 1850 MHz to 1870 MHz. Therefore, the Tx band may be separated into two bands: one from 1850 MHz to 1890 MHz, and the other from 1890 MHz to 1910 MHz.

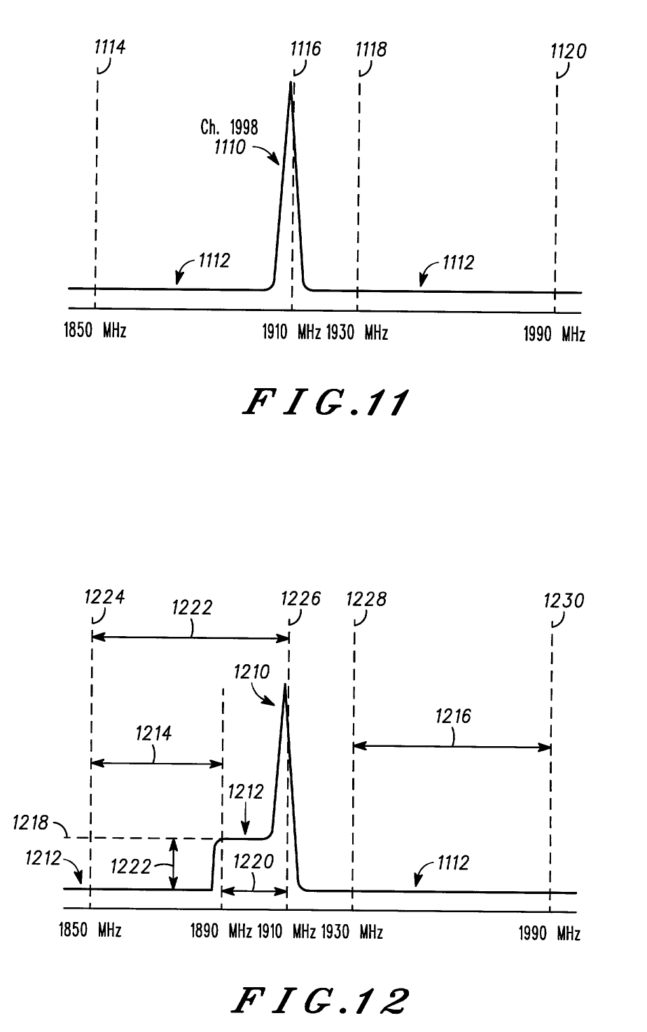

Assigning these bands to the filters in FIG. 8, FIG. 9 illustrates the frequency response 910 of the first filter 820 having a passband, Tx_{PB1} 912, from 1850 MHz 914 to 1890 MHz 916, and FIG. 10 illustrates the frequency response 1010 of the second filter 824 having a passband, Tx_{PB1} 1012, from 1890 MHz 1014 to 1910 MHz 1016. The filters 820 and 824 have an inband insertion loss, IL₁_{_{—}}ᵢₙ 918 and IL₂_{_{—}}ᵢₙ 1018, respectively, and an outband insertion loss, IL₁_{_{—}}ₒᵤₜ 920 and IL₂_{_{—}}ₒᵤₜ 1020, respectively.

The radiophone is first assigned a Tx channel, for example, Channel 1998 which has the frequency of 1909.92 MHz. The path of the Tx signal is predetermined based on the channel assignment, and by recognizing that the Tx signal produced at this channel will have to go through the path with the second filter 824, the radiophone appropriately activates the first and the second switches, 814 and 828, respectively. The modulator 810 then produces the Tx signal on Channel 1998 at the frequency of 1909.92 MHz. A representation of this Tx signal 1110 at the output 812 of the modulator 810 is illustrated in FIG. 11. At this stage, the noise floor 1112 associated with the Tx signal 1110 is relatively uniform.

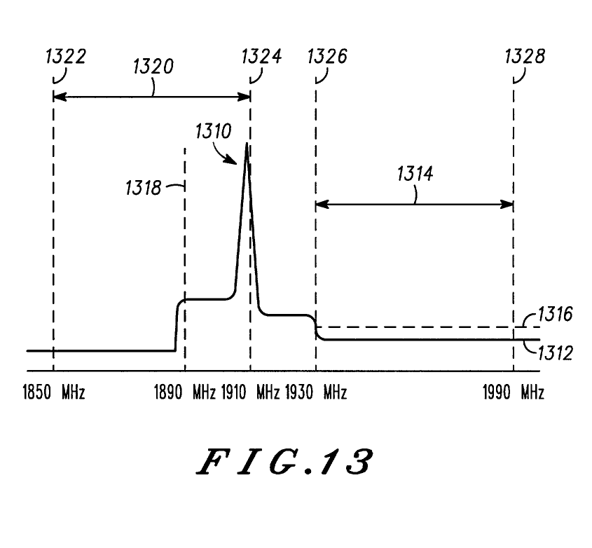

Because of the first and second switches, the Tx signal is sent through the filter 824 and the filtered Tx signal is produced at the input of the PA 832. A representation of this filtered Tx signal 1210 and its associated noise floor 1212 at the input 830 of the PA 832 are illustrated in FIG. 12. As illustrated, the noise floor 1212 associated with the Tx signal 1210 is no longer uniform, and the Tx band region 1214 that could be folded over to appear as noise in the Rx band 1216 is reduced relative to the noise floor level 1218 within the passband 1220 of the filter 824 which falls outside of the Rx band 1216 when it is folded over. This reduction in the magnitude 1222 of the noise floor is equal to the out-of-band attenuation 1020 of the filter 824. This Tx signal 1210 with reduced noise floor now enters the PA 832. The noise floor associated with the Tx signal contributes to production of foldover noise due to intermodulation phenomenon caused by nonlinearity of the PA. However, because the region 1214 of the noise floor within the Tx band 1220 has been reduced by going through the filter 824, and because the foldover noise generation is a nonlinear phenomenon, the resulting reduced noise floor in the region 1214 contributes significantly less to the foldover noise produced by the PA. A representation of the resulting Tx signal 1310 at the output 834 of the PA 832 is illustrated in FIG. 13. At the PA output 834, the Tx signal 1310 now has low enough noise level 1312 in the Rx band 1314 not to require further filtering by a post-PA filter to meet the Rx band noise requirement 1316.

By eliminating the post-PA filter, the PA is no longer required to produce extra power to overcome the loss that would have been encountered by Tx signal going through the post-PA filter, and therefore a less powerful and smaller PA device may be employed. The radiophone would consume less power to produce the RF Tx signal of the same output power level, and the circuit board space that would have been occupied by the post-PA filter would be saved thereby making the size reduction of the radiophone possible.

This example has described a radiotelephone to be operated in the PCS having a Tx architecture employing two bandpass filters that cover the Tx band with each filter having a different passband within the Tx band. Depending on the frequency coverage and the noise level requirements for the radiophone and the system such as advanced-mobile-phone-service (AMPS), time-division-multiple-access (TDMA), global-system for mobile (GSM), code-division-multiple-access (CDMA), wideband-code-division-multiple-access (W-CDMA), and third-generation services (3G), in which it is to be operated, more than two filters may be employed in a Tx architecture similar in method and construction as described in this example.

The present invention focuses on a radiotelephone for a cellular system, however, it may be used in other areas utilizing narrow or wide band system, but not limited to, a telecommunication transmission system such as a two-way pager, radiotelephone, high speed modem such as cable modem and LAN, and a cable transmission as cable TV application.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is

1. An apparatus for directing a radio frequency (RF) transmit (Tx) signal within a specific Tx band to a separate path comprising:
a switch;
a first filter coupled to the switch to receive a switched Tx signal and produce a first filtered Tx signal; and
a second filter coupled to the switch to receive the switched Tx signal and produce a second filtered Tx signal;
wherein the switch connects to one of the first and second filters based upon a channel assignment of the Tx signal within the specific Tx band.

2. An apparatus of claim 1 wherein the first filter has a first passband within the Tx band and provides higher insertion loss outside of the first passband than inside of the first passband.

3. An apparatus of claim 1 wherein the second filter has a second passband different from the first passband within the Tx band and provides higher insertion loss outside of the second passband than inside of the second passband.

4. An apparatus of claim 1 wherein the first passband and the second passband, both being within the Tx band, have no common frequency range.

5. An apparatus of claim 1 wherein the first passband and the second passband, both being within the Tx band, overlap.

6. An apparatus of claim 1 further comprising a modulator coupled to the switch, producing the Tx signal having a Tx signal frequency substantially equal to a desired RF Tx frequency.

7. An apparatus of claim 1 further comprising a second switch coupled to the first and the second filters wherein the second switch is connected to one of the first and the second filters based upon the channel assignment within the specific Tx band, and produce a second switched Tx signal.

8. An apparatus of claim 1 further comprising a power amplifier (PA) coupled to the second switch to receive the second switched Tx signal and produce an amplified Tx signal for transmission at a PA output.

9. An apparatus for generating a radio frequency (RF) transmit (Tx) signal having reduced noise by directing a RF Tx signal within a specific Tx band to a separate path comprising:
a modulator producing the Tx signal having a Tx signal frequency substantially equal to a desired RF Tx frequency;
a first switch coupled to the modulator to receive the Tx signal;
a first filter coupled to the first switch to receive a first switched Tx signal and produce a first filtered Tx signal, having a first passband within the Tx band and provides higher insertion loss outside of the first passband than inside of the first passband;
a second filter coupled to the first switch to receive the first switched Tx signal and produce a second filtered Tx signal, having a second passband different from the first passband within the Tx band and provides higher insertion loss outside of the second passband than inside of the second passband;
a second switch coupled to the first and second filters to receive the first and the second filtered Tx signal, respectively, producing a second switched Tx signal; and
a power amplifier (PA) coupled to the second switch to receive the second switched Tx signal to produce an amplified Tx signal for transmission at a PA output;
wherein the first and the second switches connect to one of the first and the second filters based upon a channel assignment of the Tx signal within the specific Tx band.

10. A method for generating a radio frequency (RF) transmit (Tx) signal having reduced noise by directing a RF Tx signal within a specific Tx band to a separate path comprising steps of:
determining an appropriate path, which is one of a plurality of paths each having a bandpass filter, for the Tx signal based upon a channel assignment of the Tx signal;
establishing the appropriate path for the Tx signal; and
sending the Tx signal through the appropriate path.

11. A method of claim 10 wherein the bandpass filter of each of the plurality of paths has a passband within the Tx band and is different from passbands of other bandpass filters.

12. A method of claim 10 wherein the appropriate path has the bandpass filter having the passband encompassing the channel assigned to the Tx signal.
